(19) United States
(12) Patent Application Publication
(10) Pub. No.: US 2014/0060263 A1
(43) Pub. Date: Mar. 6, 2014

(54) FITTING ASSEMBLY FOR HAND TOOL

(71) Applicant: Tsang-Hai LIN, Taichung City (TW)

(72) Inventor: Tsang-Hai LIN, Taichung City (TW)

(21) Appl. No.: 13/598,639

(22) Filed: Aug. 30, 2012

(51) Int. Cl. B25B 23/16; B25B 29/00

(52) U.S. Cl. 81/177.2; 279/2.23; 81/177.85

(57) ABSTRACT

The present invention is provides a fitting assembly for a hand tool with enhanced snapping capability, operation smoothness, and reduced manufacturing cost. The fitting assembly contains a body and one end of the body has a fitting member. The fitting member has a radial through channel connecting two opposing sides of the fitting member. Two steel balls and a conical spring in between are housed in the through channel. By simultaneously compressing the both ends of the conical spring through the steel balls on the fitting member, and as the smaller rings of the conical spring are squeezed into the larger rings to effectively reduce the length of the compressed conical spring and to align the steel balls' engagement direction and the axial direction of the conical spring, the fitting assembly provides enhanced snapping capability, operation smoothness in connection and detachment, and reduced manufacturing cost of the hand tool.

### TECHNICAL FIELD OF THE INVENTION

The present invention generally relates to hand tools, and especially relates to a fitting assembly for a hand tool with enhanced snapping capability and operation smoothness.

### DESCRIPTION OF THE PRIOR ART

There are various types of hand tools for different operation requirements. Whether it is a manual, pneumatic, or electrical hand tool, in order to reach a fastener in a deep or tiny place, the hand tool usually requires an extender. Additionally, the hand tool usually has interchangeable heads or sockets so as to turn different sized bolts and other fasteners. As illustrated in FIG. 1, an extender for fastening or releasing a bolt or nut contains a body 10 with a recess 11 and a fitting member 15 at its two ends, respectively. The recess 11 can be applied to a hexagonal bolt or nut, or can be fitted with a screwdriver. The fitting member 15 has a steel ball 18 sustained by an elastic element 16. The steel ball 18 is slightly exposed out of the surface of the fitting member 15 for snapping into a corresponding notch of a fitted socket. The steel ball 18 provides the required locking to prevent the extender from falling off.

When torque is applied to the recess 11 or the fitting member 15, the lack of stability of the conventional fitting assembly causes imbalance to the distribution of the torque. This phenomenon is especially significant for pneumatic or electrical hand tools.

According to R.O.C Taiwan Patent No. M390204 as shown in FIG. 2, an extender contains a body 20 having a recess 21 at one end for fitting on a bolt or nut and a fitting member 25 at the other end. The fitting member 25 is box-shaped for snapping into a socket wrench. A through channel 26 connects two sides of the fitting member 25. The fitting member 25 also contains a chamber 27 along its axial direction that also connects the through channel 26. A steel ball 28 is positioned at each of the through channel 26 and another steel ball 29 is positioned in the chamber 27 sustained by an elastic element 291. The steel ball 29 interacts with the two steel balls 28 so that they are exposed out of or retracted into the through channel 26. The fitting member 25 therefore can snap into and lock to a socket wrench by the steel balls 28.

The interaction between the steel balls 28 and 29 involves force transmission and engagement direction that are perpendicular to each other. This would affect the snapping reliability and operation smoothness, causing inconveniency in connection and detachment. In addition, the fitting member 25 requires machinery in both axial direction and radial direction, adding the difficulty in manufacturing and assembly and the manufacturing cost.

As such, the present inventor has provided a novel fitting assembly to obviate the shortcomings such as the lack of snapping capability, operation difficulty, and high manufacturing cost, etc. of the prior teachings.

### SUMMARY OF THE INVENTION

Therefore, a major objective of the present invention is provides a fitting assembly for a hand tool with enhanced snapping capability, operation smoothness, and reduced manufacturing cost.

To achieve the objective, the fitting assembly contains a body and one end of the body has a fitting member.

The fitting member has a through channel along a radial direction connecting two opposing sides of the fitting member. Two steel balls and a conical spring between the steel balls are housed in the through channel.

By simultaneously compressing the both ends of the conical spring through the steel balls on the fitting member, and as the smaller rings of the conical spring are squeezed into the larger rings to effectively reduce the length of the compressed conical spring and to align the steel balls' engagement direction and the axial direction of the conical spring, the fitting assembly provides enhanced snapping capability, operation smoothness in connection and detachment, and reduced manufacturing cost of the hand tool.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a sectional diagram showing a fitting assembly of a conventional hand tool.

FIG. 2 is a sectional diagram showing a fitting assembly of another conventional hand tool.

FIG. 3 is a perspective schematic diagram showing a fitting assembly according an embodiment of the present invention.

FIG. 4 is a perspective diagram showing the outlook of the fitting assembly of FIG. 3.

FIG. 5 is a perspective diagram showing a fitting assembly according to an embodiment of the present invention applied to a socket wrench.

FIG. 6 is a sectional diagram showing a fitting assembly according to an embodiment of the present invention when its steel balls are not compressed.

FIG. 7 is a sectional diagram showing the fitting assembly of FIG. 6 when its steel balls are compressed.

FIG. 8 is a sectional diagram showing a fitting assembly according to another embodiment of the present invention when its steel balls are not compressed.

FIG. 9 is a sectional diagram showing the fitting assembly of FIG. 8 when its steel balls are compressed.

FIG. 10 is a sectional diagram showing a fitting assembly according to yet another embodiment of the present invention when its steel balls are not compressed.

FIG. 11 is a sectional diagram showing the fitting assembly of FIG. 10 when its steel balls are compressed.

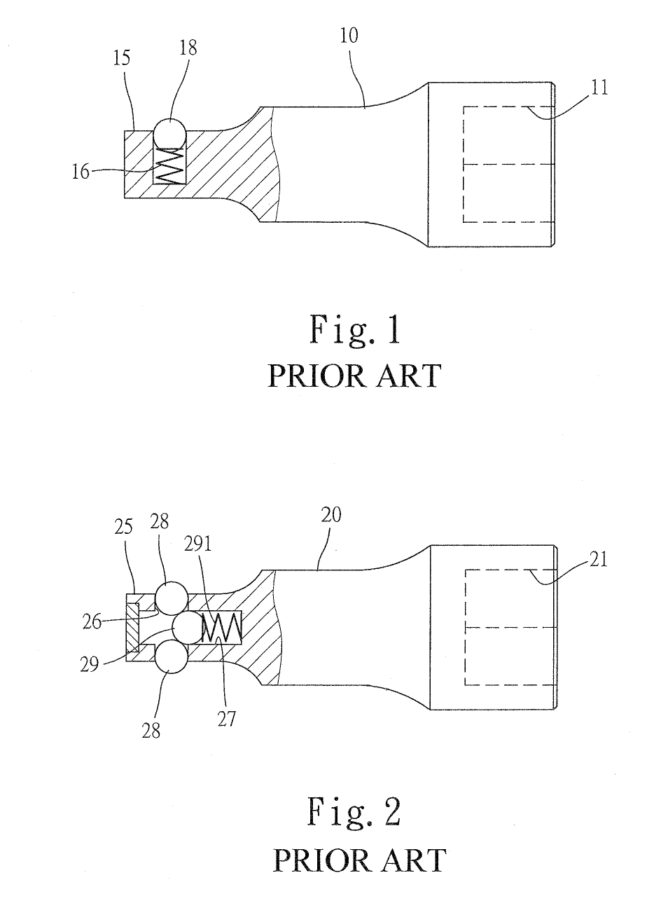

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

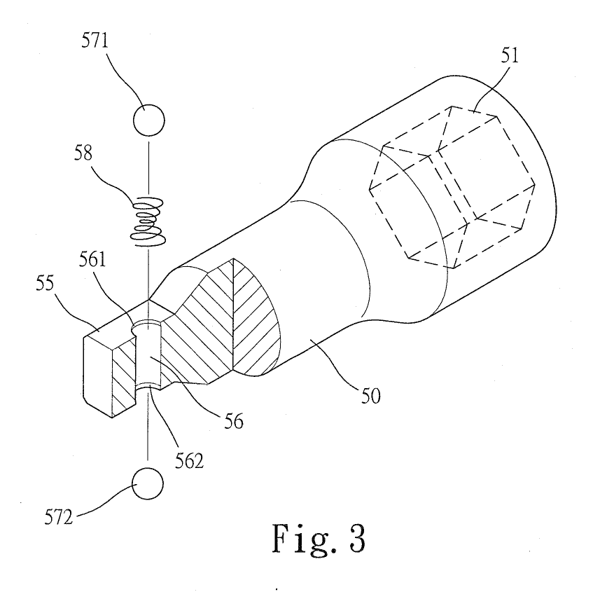

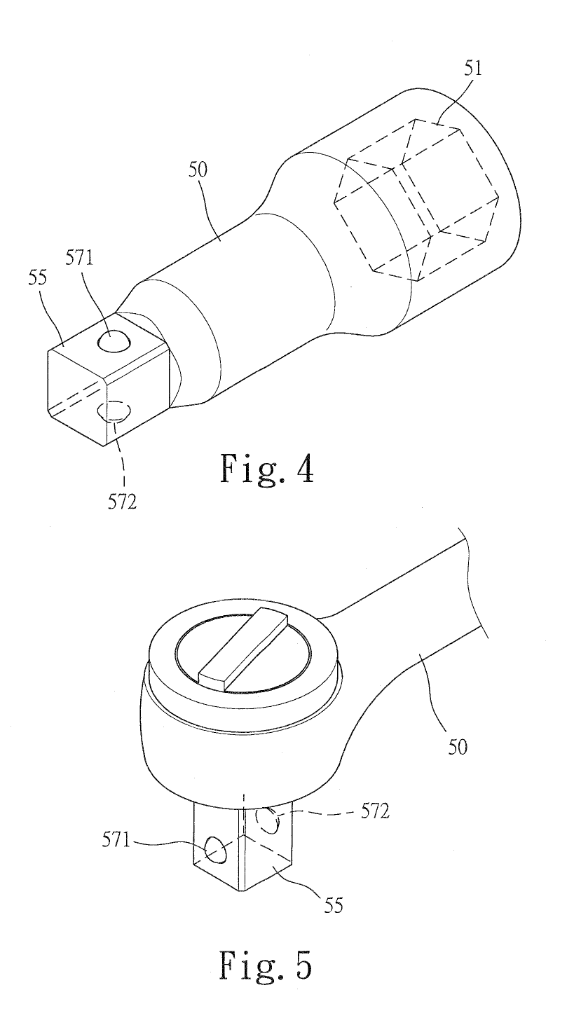

As shown in FIGS. 3 to 6, a fitting assembly for a hand tool according to an embodiment of the present invention contains a body 50. The body 50 could be a socket extender or a socket wrench. One end of the body 50 can be the handle of the hand tool, or has a recess 51 for gripping the head of a bolt. The other end of the body 50 has a box-shaped fitting member 55 for joining a socket or a socket wrench.

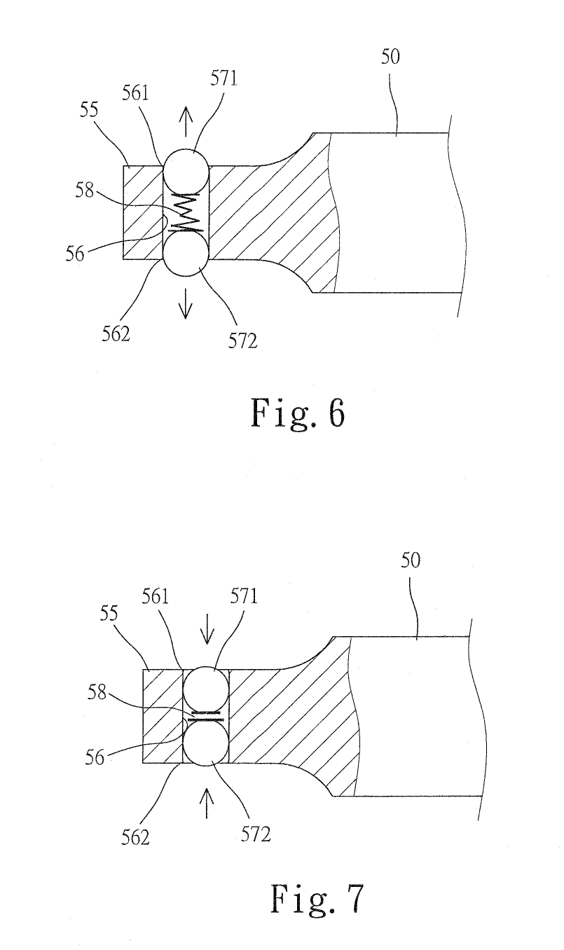

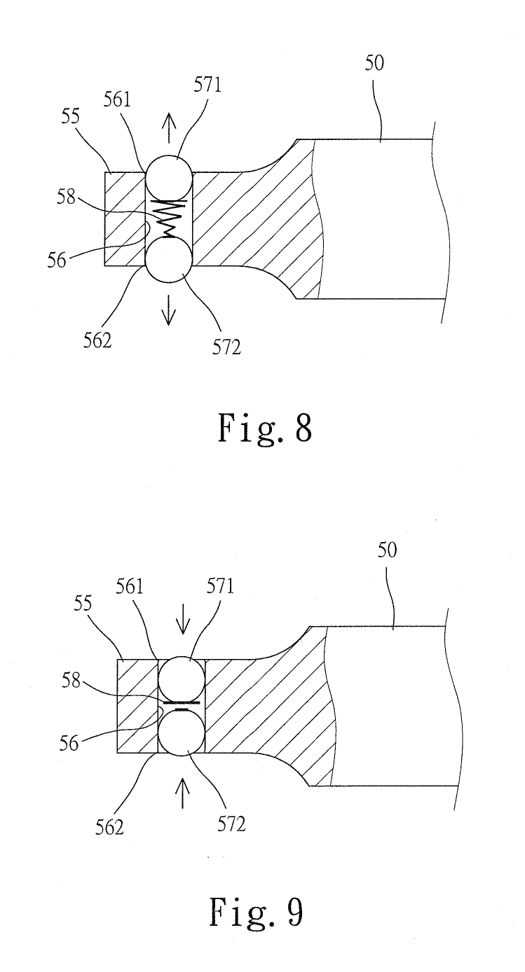

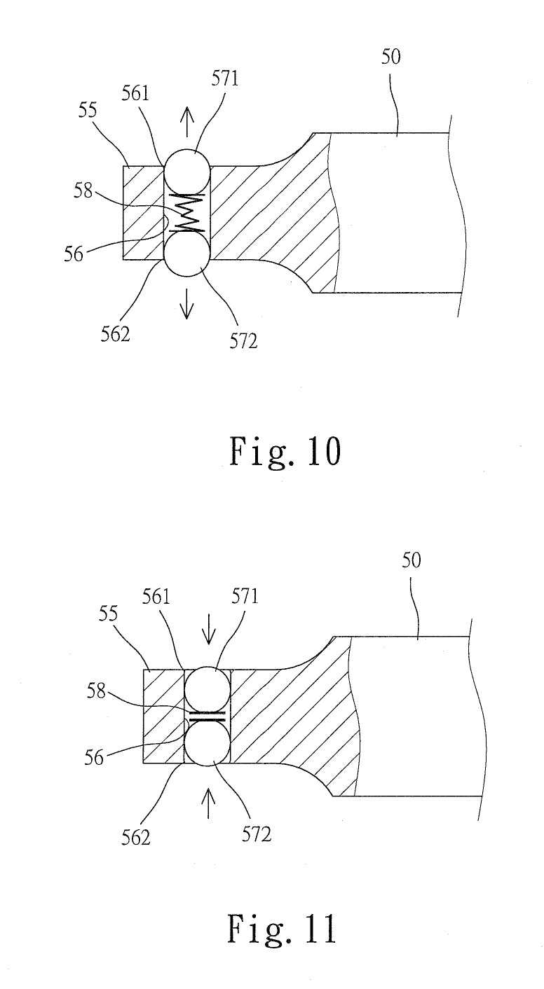

The fitting member 55 has a through channel 56 along a radial direction connecting two opposing sides of the fitting member 55. Two steel balls 571 and 572, and a conical spring 58 between the steel balls are housed in the through channel 56. The two ends of the through channel 56 are configured with edges 561 and 562, respectively, so that the steel balls 571 and 572 are slightly exposed out of the two ends of the through channel 56 without falling out. The conical spring 58 could be one that its two ends are of larger but different diameters and the middle is of a smaller diameter (as shown in FIGS. 6 and 7), or one that one end has larger diameter and the other end has smaller diameter (as shown in FIGS. 8 and 9), or one that its two ends are of a larger and identical diameter and the middle is of a smaller diameter (as shown in FIGS. 10 and 11). When the steel balls 571 and 572 are forced into the through channel 56, the conical spring 58 is compressed and the rings of smaller diameters are squeezed into the rings of larger diameters (as shown in FIGS. 6 and 7). The conical spring 58 deforms its larger rings first, and the spring constant increases as the amount of compression increases without affecting its expansion strength, thereby effectively ensuring the snapping capability of the steel balls 571 and 572.

Therefore, by simultaneously compressing the both ends of the conical spring 58 through the steel balls 571 and 572 on the fitting member 55, and as the smaller rings of the conical spring 58 are squeezed into the larger rings to effectively reduce the length of the compressed conical spring 58, the fitting assembly of the present invention provides enhanced snapping capability, operation smoothness, and reduced manufacturing cost of the hand tool.

The operation of the fitting assembly of the present invention is as follows. As shown in FIGS. 6 to 11, when the fitting member 55 is to be joined with or detached from a socket, the steel balls 571 and 572 of the fitting member 55 are forced into the through channel 56, the conical spring 58 sustaining the steel balls 571 and 572 deforms its larger rings first and its smaller rings are squeezed into the larger rings. The sustaining strength of the conical spring 58 to the steel balls 571 and 572 are not affected, yet the snapping capability of the steel balls 571 and 572 are effectively enhanced.

Additionally, as the steel balls 571 and 572 move along the same axis where the conical spring 58 expands and shrinks, the length of the compressed conical spring 58 is effectively reduced, and the fitting member 55's joining with a socket is smooth with enhanced snapping capability, thereby increasing the value and performance of the hand tool.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fitting assembly for a hand tool, comprising a body, wherein one end of the body has a fitting member;
the fitting member has a through channel along a radial direction connecting two opposing sides of the fitting member;
two steel balls and a conical spring between the steel balls are housed in the through channel; and
by simultaneously compressing the both ends of the conical spring through the steel balls on the fitting member, and as the smaller rings of the conical spring are squeezed into the larger rings to effectively reduce the length of the compressed conical spring, the fitting assembly provides enhanced snapping capability, operation smoothness, and reduced manufacturing cost of the hand tool.

2. The fitting assembly for a hand tool according to claim 1, wherein the body is one of a socket extender and a socket wrench.

3. The fitting assembly for a hand tool according to claim 1, wherein the two ends of the through channel are configured with edges, respectively, so that the steel balls are slightly exposed out of the two ends of the through channel without falling out.

4. The fitting assembly for a hand tool according to claim 1, wherein the conical spring is one that its two ends are of larger but different diameters and the middle is of a smaller diameter.

5. The fitting assembly for a hand tool according to claim 1, wherein the conical spring is one that its two ends are of a larger and identical diameter and the middle is of a smaller diameter.

6. The fitting assembly for a hand tool according to claim 1, wherein the conical spring is one that one end has larger diameter and the other end has smaller diameter.
